(19) United States
(12) Patent Application Publication
(10) Pub. No.: US 2006/0206544 A1
(43) Pub. Date: Sep. 14, 2006

(54) Automatic backup and restore system and method

(75) Inventors: Artem Oks, Bellevue, WA (US); Martin J. Sleeman, Redmond, WA (US); Rajesh B. Iyer, Bellevue, WA (US); Hanumantha Rao Kodavalla, Sammamish, WA (US); Peter Byrne, Bellevue, WA (US); Steven R. Schmidt, Redmond, WA (US); Mark S. Wistrom, Redmond, WA (US); Rajeev B. Rajan, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/075,675

(22) Filed: Mar. 9, 2005

(51) Int. Cl. G06F 17/30

(52) U.S. Cl. 707/204

(57) ABSTRACT

An automatic database backup and restoration system comprises an interface component that receives statements relating to backing up at least a portion of a first database, the original database resident upon a consumer computing device. A backup component associated with the interface component automatically copies at least the portion of the first database and writes the copied portion to a backup database, the backup database is a full backup of the first database. The consumer computing device can be, for example, one of a laptop computer, a desktop computer, a personal digital assistant, and a cellular phone.

### TECHNICAL FIELD

The subject invention relates generally to database management, and more particularly to automatically backing up and restoring databases resident upon consumer computing devices.

### BACKGROUND OF THE INVENTION

Computers and computer-based devices have become a necessary tool for many applications throughout the world. Typewriters and slide rules have become obsolete in light of keyboards coupled with sophisticated word-processing applications and calculators that include advanced mathematical functions/capabilities. Thus, trending applications, analysis applications, and other applications that previously may have required a collection of mathematicians or other high-priced specialists to painstakingly complete by hand can now be accomplished through use of computer technology. To properly effectuate the aforementioned applications as well as other applications that utilize data within databases, such data must be accessible and be free from corruption. Businesses that have sufficient resources can employ one or more database administrators (DBAs) to ensure that data within a database remains available to users and/or applications accessing such database. For instance, a DBA can schedule a backup of data within the database in case of occurrence of corruption therein, and thereafter effectuate such backup. If problems exist within a first copy of the data (e.g., data therein is corrupted), the second copy of the data can be utilized to restore such first copy.

As can be assumed, DBAs are a significant expense with respect to database management. For instance, DBAs typically are associated with advanced and specialized skill in the field of databases. Accordingly, individual users do not employ DBAs to monitor their hard drives to ensure data integrity therein. Furthermore, many conventional computer systems are not associated with database engines—thus rendering DBAs useless in connection with such systems. As hard drive space has expanded, however, employing database technology in consumer-level computers (such as desktop computers, laptop computers, and the like) is becoming increasingly popular. Therefore, similar problems existent with respect to database servers (e.g., data corruption) are becoming prevalent with respect to consumer-level computers.

Given the above, it is apparent that individual users, small businesses, and any other user/entity not employing a DBA to manage their database(s) is subject to various catastrophes associated with data corruption. For instance, if particular pages within a database file are subject to corruption, and no adequate backup system exists, then an entirety of a database can be lost. For typical consumer users, this can translate to loss of information associated with banking accounts, information related to photographs, entertainment, and the like, and various other data that is extremely important to an individual. Furthermore, at least a portion of data within a database can be manually entered by a user, and it may have required a substantial amount of time for the user to provide this information. In one example, a user may have thousands of different music files resident upon a hard drive, and ratings associated with the music files may have been manually entered by a user and stored in a database. A substantial amount of time was obviously necessary to enter such ranking data, and loss of such data due to data corruption will negatively affect user enjoyment associated with the music files. With respect to small businesses, corruption of a database can equate to loss of payroll information, tax information, profitability data, and various other data that is of extreme importance to the business. Thus, a loss of a database due to corruption therein can prove disastrous to both consumer users and small business users.

Conventionally, as consumers and small businesses typically do not employ DBAs, the only manner in which to protect themselves is to manually create backups of the database. Many users do not undertake such backups as they assume that their computers are not susceptible to data corruption. In other instances, a user may only sporadically remember to take a backup of an important database (e.g., once every few months). Therefore, even if such user does remember to backup the database, data within the backup may be obsolete in some respects. Moreover, if there is a corruption within data, the user must then manually copy data from the backup of the database and enter such data into an “original” database, thereby providing even further opportunity for human error (e.g., copying data to an incorrect location).

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The subject invention relates to novel systems and methods for fully backing up a database resident upon a consumer computing device and restoring the database upon detection of data corruption therein. For example, the consumer computing device can be a desktop computer, a laptop computer, a personal digital assistant, a cellular phone, or any other suitable computing device utilized by typical consumers. Thus, consumers who are not cognizant of the importance of backing up a database within their machines can be afforded a system that automatically generates the backups.

In accordance with one aspect of the subject invention, a backup of a database is effectuated by partitioning the database into a plurality of portions or database files. For instance, these files can be of a pre-defined size and/or a particular number of database files can be desired. In a specific example, the database files can desirably be approximately two gigabytes—accordingly, if the database to be backed up is ten gigabytes in size, there will exist five database files. If data is added to the database, then additional database files can be created. In a disparate example, it may be desirable to partition the database into five database files. Continuing with the above, a ten gigabyte database would be associated with five database files, each of which can be two gigabytes in size.

A full backup of the database can be created/maintained by backing up the individual data files at separate times. Therefore, if an interruption or failure occurs during backup, an entire database backup process need not be re-undertaken. Rather, only the database file that was interrupted need be backed up again. In some instances, however, it may be desirable to undertake a full backup of the database, rather than creating/maintaining backups of individual database files. The database files can be backed up at pre-defined times, during windows of time, as a function of monitored computer usage, as a function of usage of the database file, etc. For instance, backing up database files can be scheduled periodically, wherein each database filed is backed up at a disparate, specified time. In a more particular example, a database file can be scheduled for backup once a week, once a day, or any other suitable time period. Full backups of the database can be similarly scheduled.

In accordance with another aspect of the subject invention, a database associated with corrupted data therein can be automatically restored due to existence of a full backup of such database. For example, an application can access data within an original database, and a determination can be made that the data is subject to corruption. Checksums or other suitable corruption detection systems/methods can be utilized to detect physical and/or logical corruptions of data within the database. Upon determining that the original database is associated with corrupt data, data corresponding to the corrupt data within a backup of the database can be accessed and checked for corruption. If the data is not corrupt, then such data can be copied from the backup database to the original database, thereby purging the original database of corrupt data. To fully restore the original database, a transaction log associated with such database can be accessed, and transactions undertaken subsequent to backup of the portion of the original database subject to corruption can be effectuated against the original database. Accordingly, data within the original database will be fully restored. If data within the backup database is also subject to corruption, then a repair procedure can be run against both the backup database and the original database. If data is lost during the repair procedure, a user can be notified of the data loss and given an opportunity to manually restore the database.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the subject invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 is a high-level block diagram of a system that facilitates automatically creating and/or maintaining a full backup of a database within a consumer computing device in accordance with an aspect of the subject invention.

FIG. 2 is a block diagram of a system that facilitates automatically restoring a database within a consumer computing device upon detection of data corruption therein in accordance with an aspect of the subject invention.

FIG. 3 is a block diagram of a system that facilitates automatically backing up and automatically restoring a database within a consumer computing device by way of accessing and utilizing a transactional log in accordance with an aspect of the subject invention.

FIG. 4 is a block diagram of a system that facilitates automatically partitioning a database into a plurality of database files in connection with creating/maintaining a full backup of the database in accordance with an aspect of the subject invention.

FIG. 5 is a block diagram of a system that facilitates automatically repairing data associated with a corruption in a database within a consumer computing device in accordance with an aspect of the subject invention.

FIG. 6 is a flow diagram illustrating a methodology for automatically creating and maintaining a full backup of a database resident within a consumer computing device in accordance with an aspect of the subject invention.

FIG. 7 is a flow diagram illustrating a methodology for automatically restoring a database existent within a consumer computing device by way of implementing actions within a transaction log in accordance with an aspect of the subject invention.

FIG. 8 is a flow diagram illustrating a methodology for determining instances of time to undertake partial backups of a database and full backups of a database resident upon a consumer computing device in accordance with an aspect of the subject invention.

FIG. 9 is a flow diagram illustrating a methodology for automatically removing corrupt data within a database resident upon a consumer computing device in accordance with an aspect of the subject invention.

FIG. 10 is a flow diagram illustrating a methodology for automatically creating database files upon data being added to a database resident within a consumer computing device in accordance with an aspect of the subject invention.

FIG. 11 is a flow diagram illustrating a methodology for automatically restoring a database within a consumer computing device upon detection of corrupt data therein in accordance with an aspect of the subject invention.

FIG. 12 is a flow diagram illustrating a methodology for automatically restoring a database within a consumer computing device upon detection of corrupt data therein in accordance with an aspect of the subject invention.

FIG. 13 is a flow diagram illustrating a methodology for undertaking a full backup and a log backup with respect to a database in a consumer computing device in accordance with an aspect of the subject invention.

FIG. 14 is an exemplary computing environment that can be utilized in connection with the subject invention.

FIG. 15 is an exemplary operating environment that can be employed in connection with the subject invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

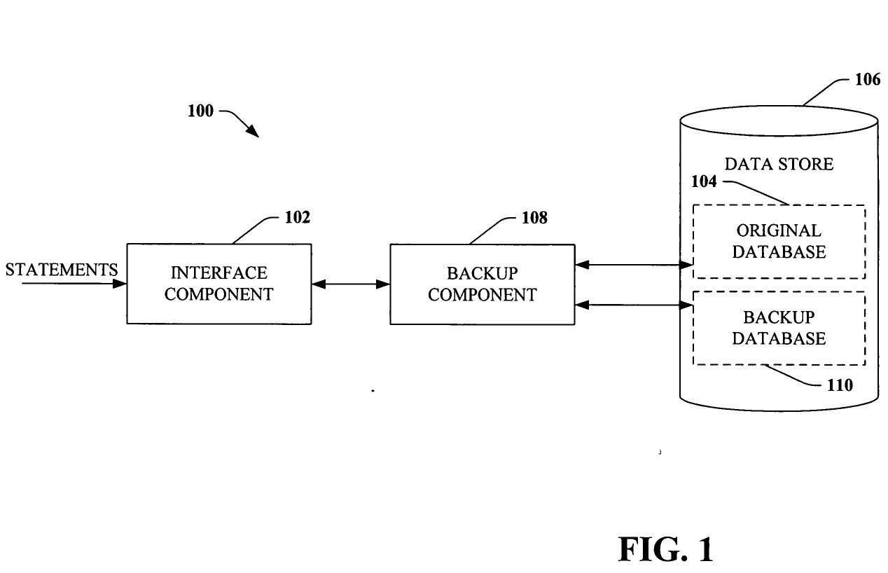

Referring now to the drawings, FIG. 1 illustrates a high-level system overview in connection with one or more aspects of the subject invention. The subject invention relates to a system 100 that facilitates automatically performing backups of databases, particularly on consumer-level computers such as personal computers, desktops, personal digital assistants, and other suitable computing devices. Databases have long been prevalent for utilization in servers, wherein database administrators (DBAs) are employed to monitor databases and ensure that they remain operational. There currently exists, however, no suitable mechanism or methodology for automatic backup and restoration of databases (e.g., on consumer level computing devices). The system 100 includes an interface component 102 that receives statements relating to backing up an original database 104 within a data store 106. For instance, the data store 106 can be a hard drive resident upon a laptop computer, personal computer, or the like. In another example, the original database 104 can be a relational database and/or a multi-dimensional database. Thus, any suitable data storage equipment and database structure is contemplated and intended to fall under the scope of the hereto-appended claims.

The statements received by the interface component 102 can be generated by a user and/or automatically generated by a computing component (not shown). For instance, statements relating to backing up the original database 104 can be received periodically to effectuate backing up at least a portion of the original database 104 at pre-determined times. In another example, content of the received statements can be a function of monitored use of the original database 104 and/or monitored use of a processing component associated with the original database 104. For instance, if other applications are being run on a computing device associated with the original database 104 and are utilizing a high percentage of processing power of the computing device, then a determination can be made to delay initiation of a backup of the original database 104. Accordingly, any suitable mechanism or method for generating statements to initiate a backup of the original database 104 can be utilized in connection with one or more aspects of the subject invention.

The interface component 102 can communicate with a backup component 108 to begin creation and/or maintenance of a backup database 110 associated with the original database 104. In particular, the backup component 108 can copy data from the original database 104 and place such data in a corresponding location within the backup database 110. Therefore, after a full backup is taken of the original database 104 and before a transaction is effectuated against the original database 104, the backup database 110 can be a full and substantially similar copy of the original database 104. In accordance with one aspect of the subject invention, the original database 104 can be partitioned into a plurality of database files, and such database files can be backed up separately. These database files can be associated with a particular size—thus, if a backup of a database file is interrupted, it will take only a fraction of the time when compared to taking a backup of the entire original database 104. In another aspect of the subject invention, full backups of the original database 104 can be scheduled, which enable backups of transactional log files to be created. Accordingly, if a corruption is located within the original database 104, data from the backup database 110 can be delivered to the original database 104, and transactions that occurred subsequent to generation of the backup database 110 can be undertaken against the original database 104. Therefore, the original database 104 can be automatically restored to a fully-functional state.

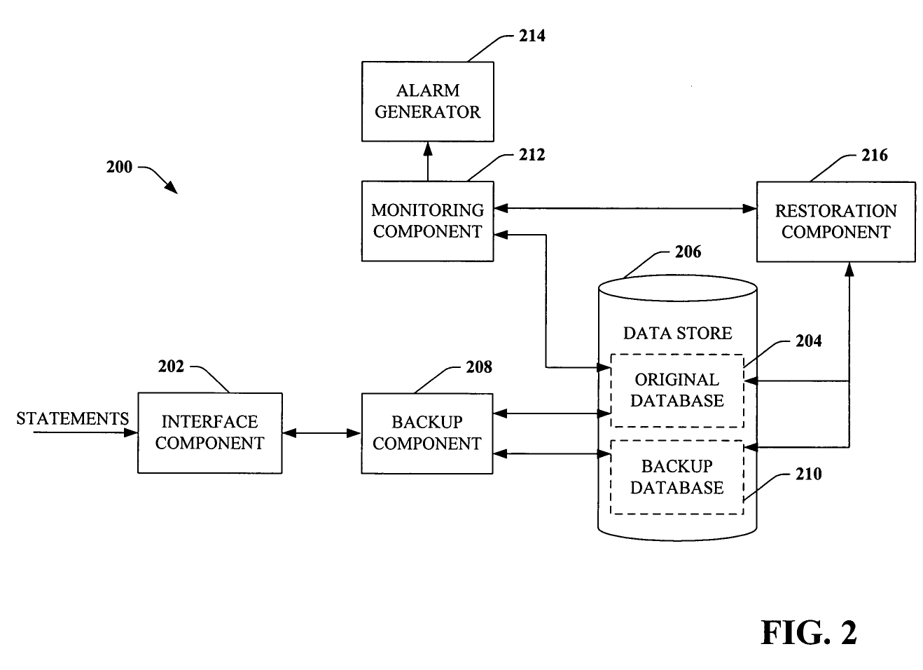

Now turning to FIG. 2, a system 200 that facilitates automatically backing up and automatically restoring the database upon detection of a corruption is illustrated. The system 200 includes an interface component 202 that receives statements that relate to backing up an original database 204 within a data store 206, such as a hard drive. The interface component 202 can be communicatively coupled to a backup component 208, which can receive the statements or translations thereof from the interface component 202. The backup component 208 can then execute the statements against the data store 206, causing creation and/or updating of a backup database 210. As described above, the original database 204 can be partitioned into a plurality of portions or files of a threshold size (e.g., 2 gigabytes). The backup component 208 can then copy particular portions of the original database 204 at specified times and place such portions in the backup database 210, thereby incrementally creating/maintaining the backup database 210. Furthermore, full backups of the original database 204 can be effectuated by way of the backup component 208 at other specified times for redundancy as well as to create backups of transaction logs associated with the original database. Furthermore, transaction logs associated with each specified portion of the original database 204 can be created.

A monitoring component 212 can be utilized to monitor operations associated with the original database 204 and detect corruptions therein. For instance, an application can access data within the original database 204 and attempt to perform data manipulation upon corrupt data within such database 204. The monitoring component 212 can detect the corrupt data and, in one aspect of the subject invention, output a flag indicating that corrupt data is existent within the original database 204. The flag can be relayed to an alarm generator 214, which can inform a user of existence of the corrupt data and further inform the user that operations are being currently undertaken to correct the corrupt data. The alarm generator 214 can output a visual alarm, an audio alarm, or any other suitable alarm to inform the user of existence of corrupt data and attempts to correct such data.

The monitoring component 212 can further communicate with a restoration component 216 to inform such restoration component 216 of existence of corrupt data and location(s) of corrupt data within the original database 204. The restoration component 216 can thereafter access the backup database 210 and determine whether corresponding data within the backup database 210 is also corrupt. If the data is not corrupt within the backup database 210, the restoration component 216 can copy the data and place it within the original database 204. Accordingly, the original database 204 will be restored to a point in time of a most-recent backup of the data. To completely update the data, the restoration component 216 can access a transactional log and undertake transactions (effectuated subsequent to the occurrence of backing up the portion of the original database 204 subject to corruption) upon the original database 204 to fully restore such original database 204).

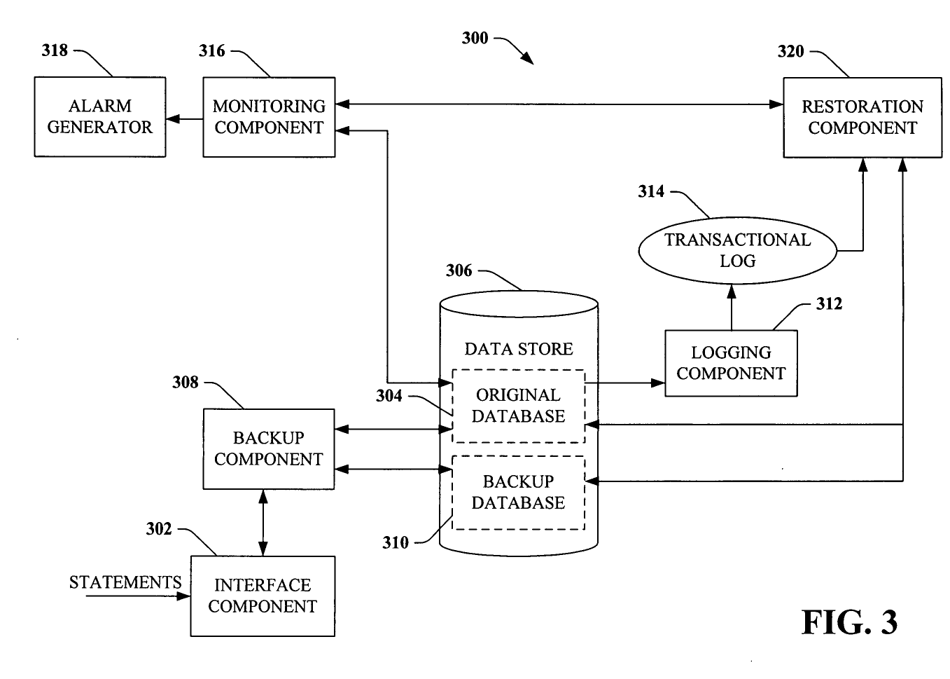

Now turning to FIG. 3, a system 300 that facilitates automatically backing up a database and automatically restoring the database upon occurrence of a corruption is illustrated. The system 300 includes an interface component 302 that receives statements relating to backing up an original database 304 within a data store 306. For instance, the statements can be delivered to the interface component 302 periodically at specified times (e.g., once a day, once a week, . . . ). Moreover, the statements can relate to disparate portions of the original database 304 that are to be backed up and/or can relate to undertaking a full backup of the original database 304. In accordance with one aspect of the subject invention, content of the statements can be a function of utilization of the original database 304. More specifically, certain portions of the original database 304 can be subject to greater amounts of alteration when compared to disparate portions of the original database 304. The statements, then, can cause updating of the portions subject to high alteration in greater frequency than the portions not subject to high amounts of alteration. Content of the statements, however, can be based upon any stimuli or indicia that effectuates efficient backing up of the original database 304.

A backup component 308 then receives the statements from the interface component 302 (or translated versions thereof) and copies at least a portion of the original database 304. The backup component 308 can then write the copied portion into a backup database 310. Thus, the backup database 310 can be substantially similar to the original database 304 after a full backup (and prior to data modification being undertaken upon the original database 304). Therefore, if data corruption exists within the original database 304, then at least a portion of the backup database 310 can be transferred to the original database 304 to correct such corruption. The system 300 further comprises a logging component 312 that monitors transactions undertaken upon the original database 304. For instance, statements executed against the original database 304 can be recorded by the logging component 312 and stored within a transactional log 314. The transactional log 314 can be maintained in a manner to include transactions effectuated against the original database 304 but not represented within the backup database 310. Moreover, the transactional log 314 can be truncated to remove extraneous transactions from therein. For example, if the backup component 308 takes a full backup of the original database 304 (e.g., copies the original database 304 and writes to the backup database 310), then all transactions within the transactional log 314 can be removed. In accordance with another aspect of the subject invention, the logging component 312 can create transactional logs corresponding to various portions of the original database 304 (e.g., different transactional logs can be created for separate database files). Accordingly, if a portion of the original database 304 is backed up by way of the backup component 308 and placed into the backup database 310, then a transactional log associated with such portion can be truncated.

The system 300 further includes a monitoring component 316 that watches the original database 304 and determines whether data corruption (physical or logical) exists within the original database 304. Moreover, the monitoring component 316 can determine extent of data corruption, location of data corruption, whether the data corruption is associated with a boot page, etc. The monitoring component 316 can be associated with an alarm generator 318 that informs a user of a corruption existent within the original database 304. The monitoring component 316 can communicate with a restoration component 320 that automatically restores the original database 304 to a fully functioning condition (e.g., without corruption) upon the monitoring component 316 detecting a corruption within such original database 304. For instance, upon receiving notification of existence and location of corrupt data within the original database 304 by the monitoring component 316, the restoration component 320 can access the backup database 310 and copy data corresponding to the corrupt data within the original database 310. Thereafter, the restoration component 320 can overwrite the corrupt data within the original database 304 with corresponding data (not subject to corruption) within the backup database 310. Thus, the original database 304 will be purged of the corrupted data. The restoration component 320 can then access the transactional log 314 generated by the logging component 312 and effectuate transactions that enable the original database 304 to be updated to a most-recent condition (minus data corruption). While not shown, the transactional log 314 can be within the data store 306 and associated with the original database 304 and/or the backup database 310. Furthermore, the backup component 308 can be employed to create a backup of the transactional log 314 in case of data corruption associated therewith. The monitoring component 316 and/or the restoration component 320 can determine that the transactional log 314 is associated with corrupt data and employ a backup of such log 314 to restore the original database 304. In case of loss of data, the alarm generator 318 can inform a user experiencing such data loss to enable manual correction of the original database 304.

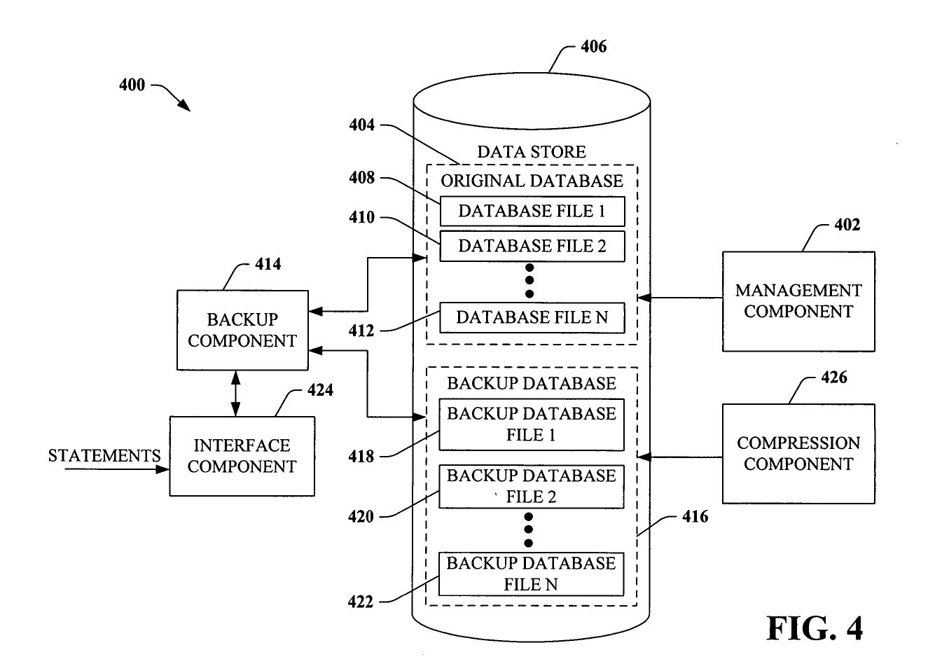

Now turning to FIG. 4, a system 400 that facilitates partitioning a database and thereafter automatically backing up and automatically restoring the database through utilization of the partitions is illustrated. The system 400 includes a management component 402 that can be utilized to partition an original database 404 within a data store 406 to a plurality of database files 408-412. These database files 408-412 can each include one or more pages, wherein data within the pages may be subject to corruption. As data is added to the original database 404, the management component 402 can create additional database files. For example, the management component 402 can create database files of approximately 2 gigabytes in size. If the original database 404 is approximately 6 gigabytes in size, then the management component 402 can create and/or maintain three database files. If data is added to the original database 404 causing it to increase in size over 6 gigabytes, then the management component 402 can create a fourth database file and place subsequently added data therein.

The system 400 further includes a backup component 414 that creates and/or maintains a backup database 416 of the original database 404. While shown as being resident within a same data store 406, it is understood that the original database 404 and the backup database 416 can be existent upon disparate data stores/hardware devices. For instance, the original database 404 can be geographically remote from the backup database 416 and communicatively coupled by any suitable communication lines (e.g., wireless, wireline, or a combination thereof). The backup component 414 can create backup database files 418-422 that correspond to the database files 408-412. Thus, by backing up the database files 408-412 separately (e.g., at different times), the backup component 414 can create a suitable backup (e.g., the backup database 416) of an entirety of the original database 404. Thus, if a backup procedure is interrupted due to power loss or other system failure, rather than having to re-undertake a backup of the full original database 404, only one of the database files 408-412 being backed up at time of failure need be subject to a re-initiated backup procedure. In accordance with another aspect of the subject invention, the backup component 414 can be employed to undertake a full backup of the original database 404. This full backup can be initiated periodically, as a function of processing power currently being utilized, when a computing device is in a hibernating mode, or any other suitable triggering mechanism. Furthermore, the backup component 414 can be employed in such a manner that it requires processing resources below a pre-defined threshold to effectuate a backup of one of the database files 408-412 and/or a full backup of the original database 404. For instance, the backup component 414 can be restricted to utilizing 10% of processing resources in connection with backing up the original database 404 and/or one of the database files 408-412 associated therewith.

In accordance with another aspect of the subject invention, the backup component 414 can be initiated upon an interface component 424 receiving statements relating to backing up the original database 404. The statements can relate to which database file(s) 408-412 are to be backed up, what time the database file(s) are to be backed up, whether a full backup of the original database 404 is to be undertaken, and the like. The system 400 can further include a compression component 426 that can compress the backup database 416 (e.g., the backup database files 418-422 therein) if size of the backup database 416 becomes an issue. The compression component 426 can further decompress one or more of the backup database files 418-422 if data not subject to corruption need be extracted therefrom.

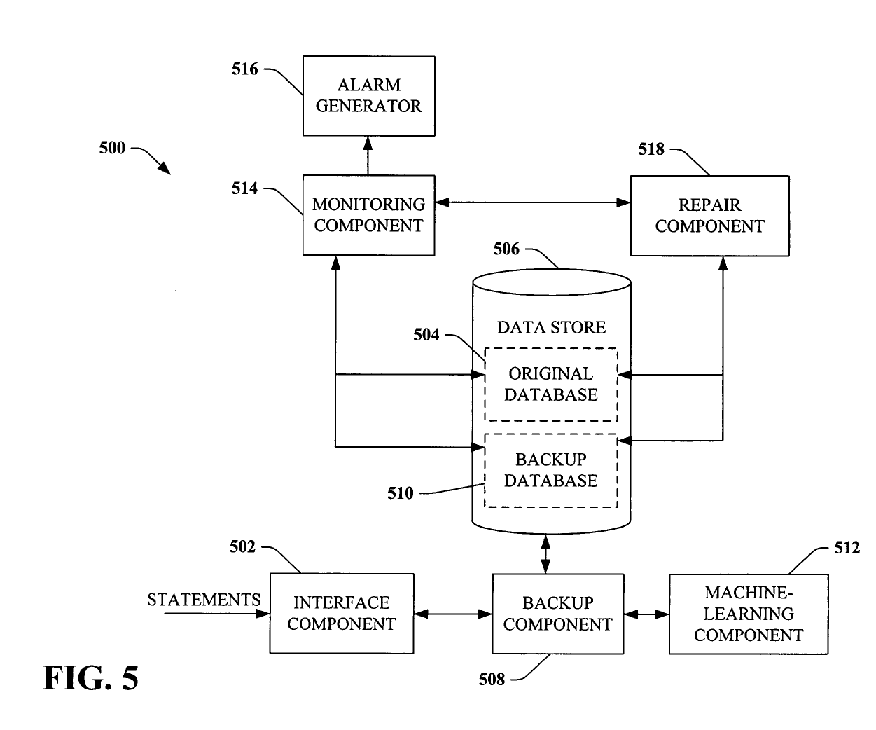

Now referring to FIG. 5, a system 500 that facilitates automatically backing up and automatically restoring a database is illustrated. The system 500 includes an interface component 502 that receives statements relating to backing up an original database 504 resident within a data store 506. For instance, the statements can relate to times that the original database 504 is to be backed up, which portions of the original database 504 are to be backed up, etc. Such statements or translations thereof can be delivered to a backup component 508 that creates a backup database 510 corresponding to the original database 504. The backup component 508 can be associated with a machine-learning component 512 that assists the backup component 508 by making inferences relating to the original database 504 and the backup database 510. As used herein, the terms to “infer” or “inference” refer generally to the process of reasoning about or inferring states of a system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

For instance, the machine-learning component 512 can monitor use of the system 500 over time to determine optimal times for backing up particular portions of the original database 504, as well as assist in determining which portions of the original database 504 are to be backed up. Thus, if the machine-learning component 512 determines that a user typically does not utilize a computer during a certain period of time (e.g., during dinner hours, particular hours of the night, . . . ), the machine-learning component 512 can schedule backups to be undertaken at such times. In another example, the machine-learning component 512 can undertake a probabilistic analysis in connection with determining which portions are to be backed up. More particularly, the machine-learning component 512 can analyze portions of the original database and calculate probabilities associated with a need for backing up such portions. The calculated probabilities can be a function of time between backups, number of modifications undertaken to the portions of the original database 504, type of modifications made to the original database 504, hard drive sector that each portion resides, or any other suitable parameter. Based upon the calculated probabilities, the backup component 508 can select which portion or portions of the original database 504 to back up as well as which times to back up the selected portion(s). Furthermore, the machine-learning component 512 can make inferences regarding whether an entirety of the original database 504 should be backed up. In accordance with one aspect of the subject invention, the machine-learning component can utilize Bayesian Belief Systems, Neural Networks, Fuzzy Logic, or any other suitable machine-learning systems and/or methodologies.

The system 500 further includes a monitoring component 514 that watches utilization of the original database 504 and detects corruption existent within such original database 504. For instance, the monitoring component 514 can be associated with an application (not shown) that is accessing data within the original database 504. If the application attempts to access/utilize corrupt data, the application will be unable to continue and the monitoring component 514 will detect existence of the corrupt data. Upon detection, the monitoring component 514 can set a flag or output a signal indicative of the corruption, and such signal/flag can be read or received by an alarm generator 516, which can alert a user of the corruption. The monitoring component 514 can also analyze data within the backup database 510 corresponding to the corrupt data within the original database 504 to determine whether the data within the backup database 510 is also corrupted. If the monitoring component 514 determines corruption of corresponding data within the original database 504 and the backup database 510, a signal indicating existence of such corruption and location thereof can be received by a repair component 518. The repair component 518 can then analyze the portions of the original database 504 and the backup database 510 to determine types of repairs necessary to enable the original database 504 to be fully functional. Any suitable repairing algorithm to undertake such repairs can be utilized by the repair component 518, and employment of such algorithms is contemplated by the inventors of the subject invention. In some instances, the repair component 518 may remove or delete data in order to repair the original database 504. In such an occurrence, the repair component 518 can inform the alarm generator 516 that data has been lost, and the alarm generator 516 can alert a user of the data loss by way of a graphical user interface (GUI), for example.

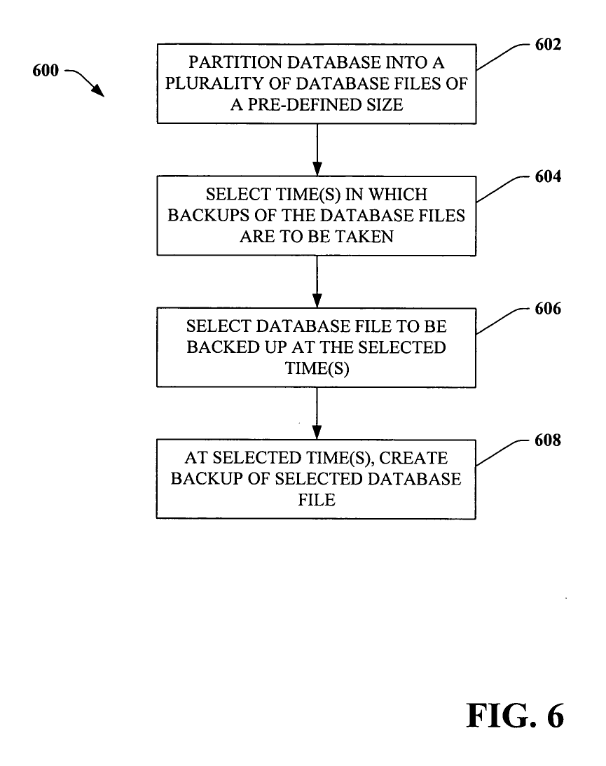

Referring to FIGS. 6-13, methodologies in accordance with various aspects of the subject invention are illustrated. While, for purposes of simplicity of explanation, the methodologies are shown and described as a series of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

Now turning solely to FIG. 6, a methodology 600 that facilitates automatically backing up a database existent, for example, on a consumer-level computer (e.g., a desktop computer, a laptop computer, a personal digital assistant, . . . ) is illustrated. At 602, a database is partitioned into a plurality of database files of a pre-determined size. For instance, the size can be one gigabyte, and the database can be approximately nine gigabytes in size. Accordingly, the database can be partitioned into nine separate database files. If the database is in the process of being created or data is added to the database, then additional database files can be created. Thus, continuing with the above example, if data is added causing the database to be over nine gigabytes in size, a tenth database file can be created.

At 604, times in which backups of the database files are to be taken can be selected. In accordance with one aspect of the subject invention, each database file can be periodically updated at certain times, which ensures consistency and predictability with respect to creating a backup of the database. For instance, if there are six database files, one of the six database files can be backed up every day (e.g., Monday through Saturday). On the remaining day of the week, a full backup of the database can be taken. Thus, a user will be aware when backups are going to take place and be certain with respect to times that a backup is to occur or has occurred. In accordance with another aspect of the subject invention, the times in which to backup the database files can be a function of utilization of the files, a function of computer usage, or any other suitable parameter.

At 606, particular database files to be backed up at the selected times are chosen. Therefore, for instance, if it is determined that a database file is to be backed up daily at a certain time, then at 606 a database file to backup at such times is selected. At 608, a backup of the selected database files is undertaken at the selected time(s). The methodology 600 thus ensures that a full backup of the database will be available without significantly interfering with use of a computing device containing the database.

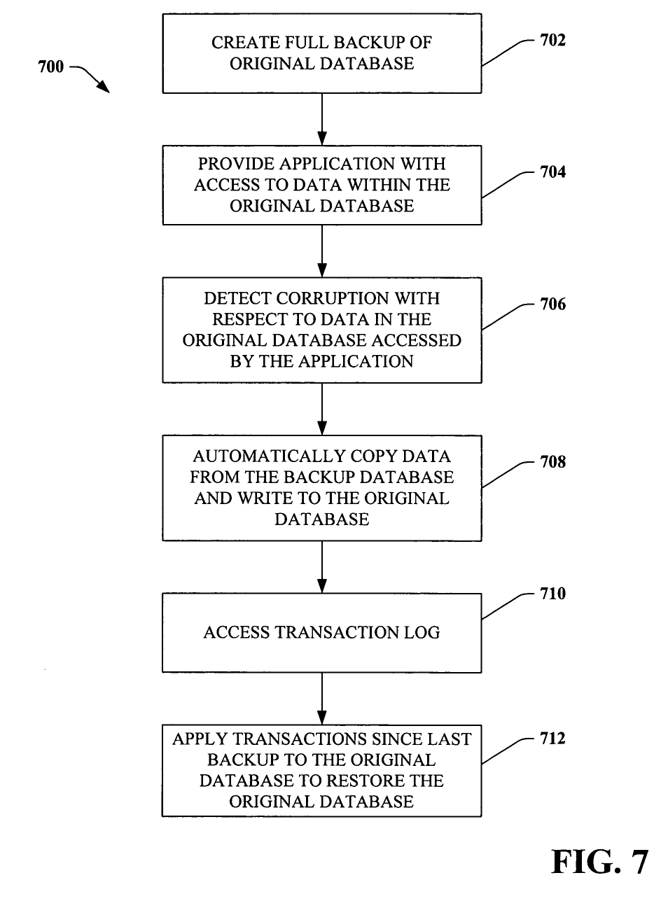

Turning now to FIG. 7, a methodology 700 that facilitates automatically restoring a database upon location of a corruption therein is illustrated. In accordance with one aspect of the subject invention, the methodology 700 can be undertaken upon a desktop computer, a laptop computer, a personal digital assistant, a cellular phone, or any other suitable consumer-level computing device. At 702, a full backup of the original database is created. This full backup can be created during a single implementation and/or can occur through incrementally backing up portions of the original database. At 704, an application is provided with access to data within the original database. For example, an entertainment media player can be provided access to ratings information associated with particular media. At 706, corruption is detected with respect to data in the original database accessed by the application. Continuing with the above example, rating data associated with a desired song can be corrupt and unreadable by the entertainment media player.

At 708, data is automatically copied from the backup database and written to the original database. This copying of data purges the original database of the corrupt data and replaces it with uncorrupted data existent within the backup database. At 710, a transaction log associated with the original database is accessed. The transaction log will include at least transactions undertaken upon the original database subsequent to a most-recent occurrence of a backup. At 712, the transactions undertaken since a most-recent backup can be applied to the original database to restore such original database. Thus, data within the original database can be restored while removing corrupt data therefrom.

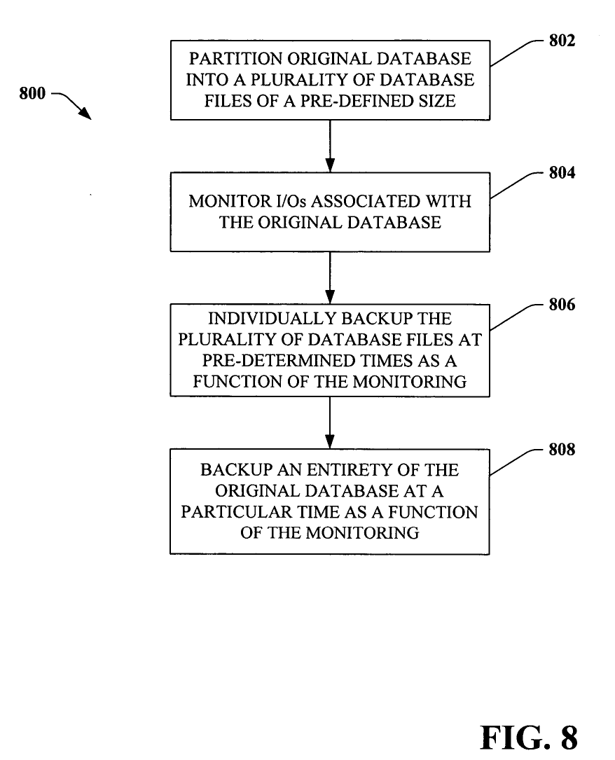

Now turning to FIG. 8, a methodology 800 for automatically backing up a database while considering utilization of such database as well as other applications is illustrated. The methodology 800 thus enables a backup to be undertaken without affecting usability of a computing system. At 802, an original database is partitioned into a plurality of database files of a pre-defined size. At 804, I/Os associated with the original database are monitored. For instance, if an application is running and utilizing the database, it is desirable to not affect such application. Furthermore, computer usage can be monitored and backups can be taken so as not to affect usability of a computer. At 806, each of the plurality of database files are individually backed up at pre-determined times as a function of the monitoring. At 808, an entirety of the original database is backed up at a particular time as a function of the monitoring. For instance, a time to undertake a full backup can be a function of content of log files (e.g., if a cumulative size of log backups undertaken is 40% of the size of the full backup), a function of time since last full backup, etc. Moreover, if a corruption is detected during a backup, a full backup can be undertaken. As described above with respect to act 806, the full backup can be undertaken without affecting usability of a computer system.

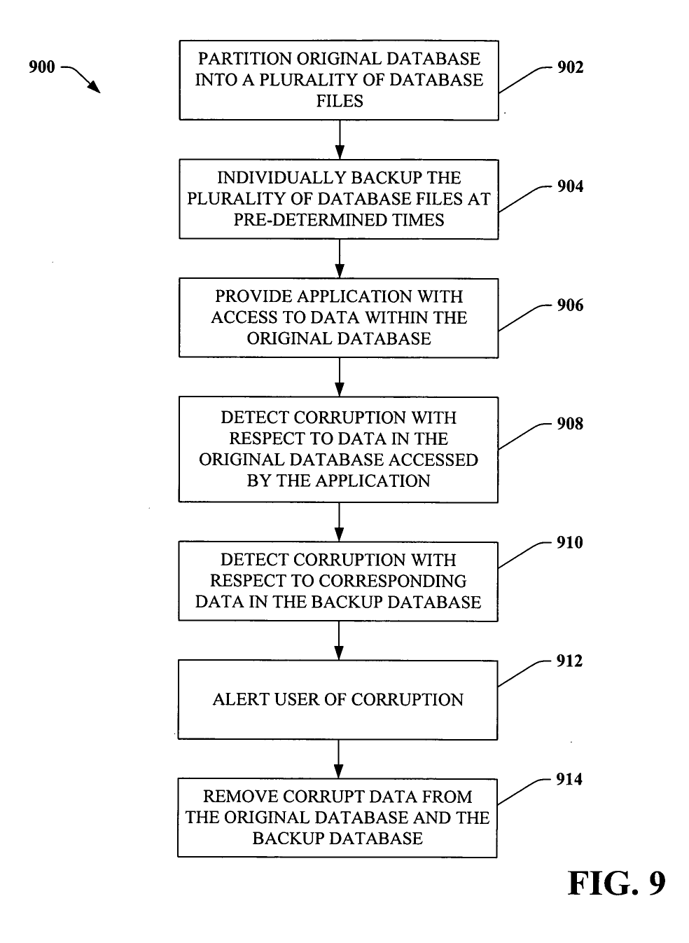

Now referring to FIG. 9, a methodology 900 for repairing a database that includes corrupt data is illustrated. At 902, an original database is partitioned into a plurality of database files. In accordance with an aspect of the subject invention, the size of the database files can be within a range of sizes and/or be a function of a number of desired database files. Therefore, if it is desired that a certain number of database files be existent regardless of the size of an entirety of the database, then the size of the database files relates to the certain number of desired database files. At 904, each of the plurality of database files are backed up at disparate pre-determined times (so as to avoid backing up two database files at substantially similar times). At 906, an application is provided with access to data within the original database. At 908, corruption with respect to data in the original database accessed by the application is detected. For instance, checksums can be employed to detect physical corruption within a database. Other suitable systems and methods for detecting physical and/or logical corruptions are also contemplated.

At 910, a corruption within the backup database that corresponds to the corruption within the original database is detected. Therefore, even if data is copied from the backup database to the original database, data corruption will remain. At 912, a user is alerted of the corruption through any suitable alarm system and/or method. At 914, corrupt data is removed from the original database and the backup database, thereby placing the database in a fully functional mode. Communications can be delivered to the application requesting the removed data to cancel requests for such data.

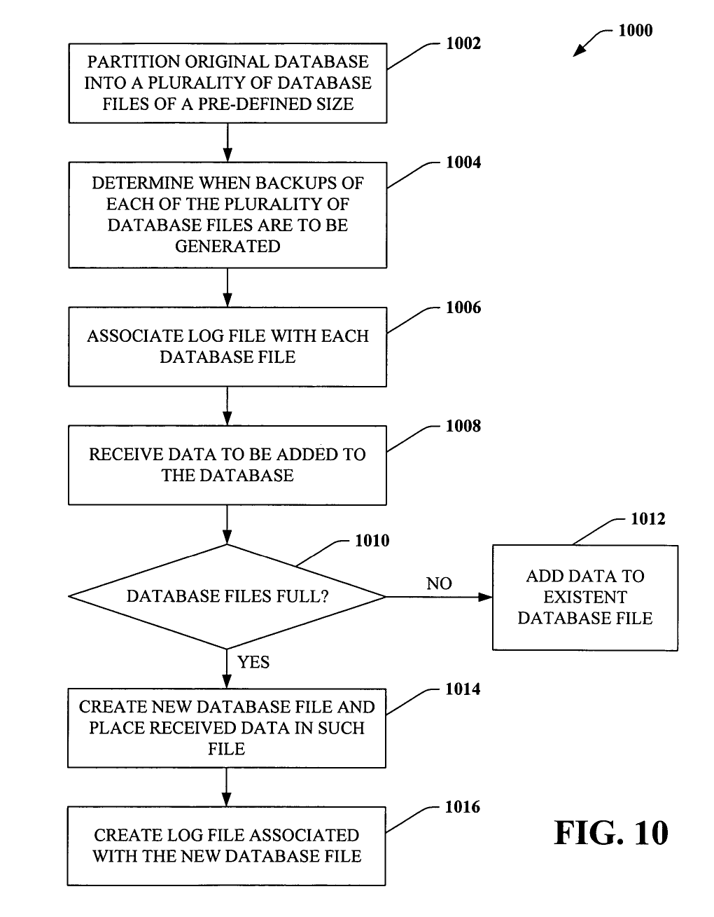

Now turning to FIG. 10, a methodology for creating and backing up database files is illustrated. At 1002, an original database is partitioned into a plurality of database files of a pre-defined size. At 1004, when backups of each of the plurality of database files are to be generated is determined. For instance, it may be desirable to backup one of the plurality of database files every twenty-four hour period. At 1006, a log file is associated with each database file. Thus, transactions undertaken against each of the plurality of database files can be logged and reviewed with respect to such database files.

At 1008, data that is desirably added to the database is received. For instance, users can provide ratings to media songs, and such ratings are desirably added to the database. At 1010, a determination is made regarding whether the database files are all full (e.g., they are all of the pre-defined size). If the database files are not full, then at 1012 data is added to an existent database file that is not at capacity. If the database file is at capacity, then at 1014 a new database file is created and the desirably added data is placed in the new database file. At 1016, a log file associated with the new database file is created (and can be backed up at a substantially similar instance in time). Moreover, at a time proximate to a time of creation of the new database file, a backup of such database file can be created.

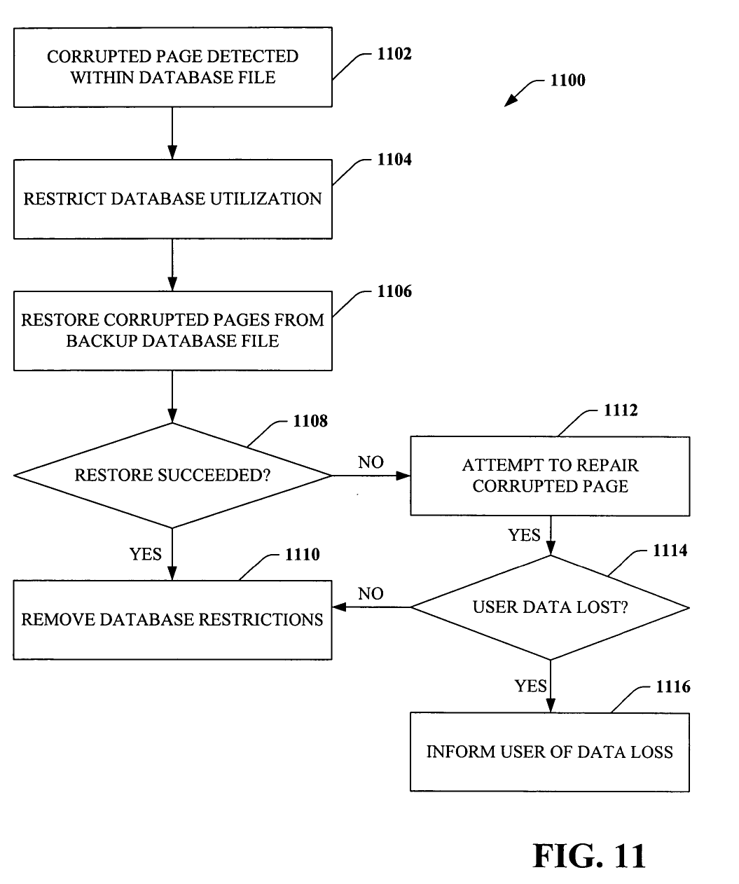

Referring now to FIG. 11, a methodology 1100 for automatically restoring and/or automatically repairing a database resident upon, for example, a consumer computing device is illustrated. At 1102, a corrupted page is detected within a database file. For instance, a database file can consist of thousands of pages, each comprising particular data. At 1104, database utilization is restricted. For example, if the database is available online, such database can be taken offline. Furthermore, the database can be restricted to one user or a set of users. At 1106, corrupted pages are restored from a backup database file. For instance, such pages can be copied from a backup database and placed in an original database, and suitable transactions can be undertaken against the copied data to restore the database. At 1108, a determination is made regarding whether the restore operation succeeded. If it did succeed, then at 1110 restrictions are removed from the database. At 1112, an attempt is made to repair the corrupted page. For instance, corrupted data can be removed from the original database and the backup database. Other suitable repair mechanisms and/or methods, however, are also contemplated. At 1114, a determination is made regarding whether there has been any data loss. If there has been no data loss, then restrictions can be removed from the database at 1110 and the database can be operated upon as desired. If there has been data loss, then at 1116 a user is informed of such data loss.

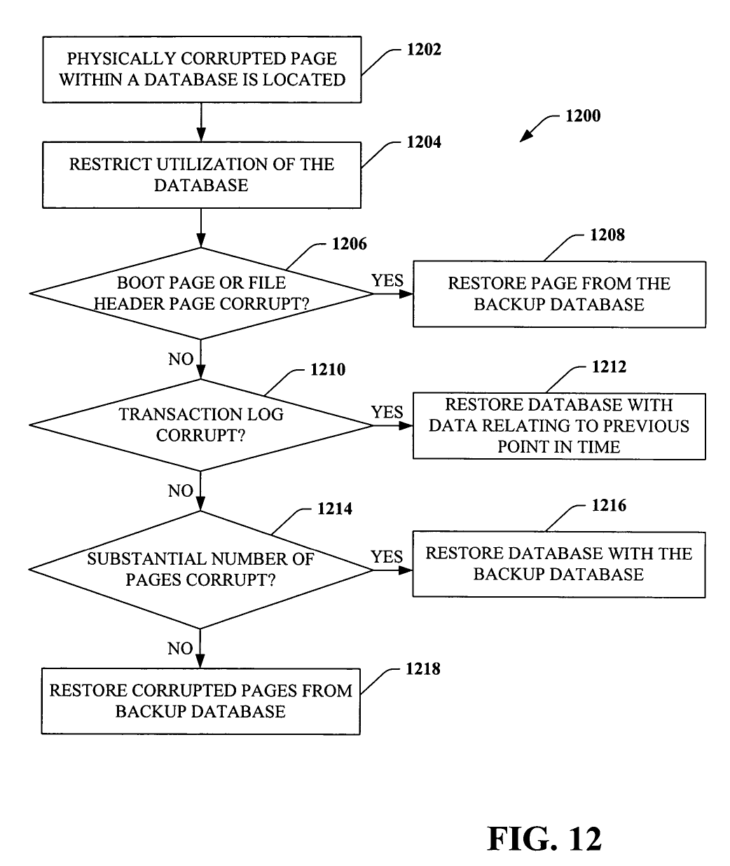

Now turning to FIG. 12, a methodology 1200 for restoring a database associated with one or more corruptions is illustrated. At 1202, a physically corrupted page within a database is located. Pages can become physically corrupted due to faulty hardware, torn writes, and media decay. To detect physical corruption of a page, checksums can be utilized to determine if a page has been physically corrupted. If a checksum is not substantially similar to an expected checksum, then a page associated therewith can be labeled as physically corrupted. At 1204, utilization of the database is restricted. For example, the database can be restricted to a single user rather than enabling a plurality of users to access such database. At 1206, a determination is made regarding whether the corrupted page is a boot page or a file header page. If the corrupted page is a boot page or a filed header page, then a corresponding page within a backup of the database is placed within the database, and transactions within a transaction log are effectuated to restore such page at 1208. If the corrupted page is not a boot page or a file header page, then a determination is made regarding whether the transaction log is corrupt at 1210. If the transaction log is found to be corrupt, then at 1212 the database is restored with data that existed at a previous point in time (e.g., transactions within the transaction log cannot be re-undertaken as such log is corrupted). If the transaction log is not corrupt, then a determination is made regarding whether a substantial number of pages are corrupt at 1214. If there are a substantial number of pages corrupt within the database, then the database is overwritten with a backup copy of the database at 1216, and a transaction log is accessed and utilized to restore the database. If there aren't a substantial number of pages corrupt, then only the corrupted pages are restored at 1218 (e.g., an entirety of the database need not be restored).

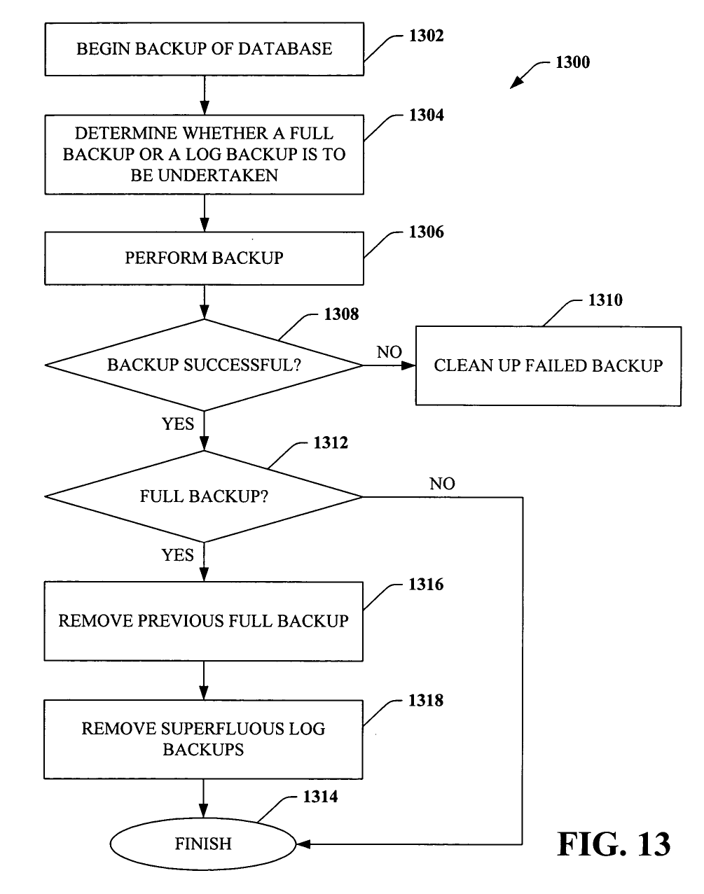

Now referring to FIG. 13, a methodology 1300 for automatically backing up a database in a consumer computing device is illustrated. At 1302, a backup of a database is initiated. At 1304, either a full backup or a log backup is selected. For example, a log backup can include obtaining backups of transactional logs associated with the database. A full backup relates to generating a copy of all data within the database and storing such copy as a backup version of the database. At 1306, the desired backup is performed, and at 1308 a determination is made regarding whether the backup was successful. If the backup was not successful (e.g., if, during the backup, corrupt data is located), then at 1310 a clean up of the failed backup is undertaken. For instance, if power is lost during the backup, then data associated with the backup is discarded. In another example, if corrupt data is found during the backup, then a restoration or repair procedure can be undertaken at 1310.

If the backup was successful, then at 1312 a determination is made regarding whether a full backup was selected. If a log backup was selected and successful, then the methodology 1300 completes at 1314. If a full backup was selected, then at 1316 a previous full backup is purged from a computer system. At 1318 superfluous log backups are removed and/or truncated to create additional storage for database data, and the methodology 1300 ends at 1314.

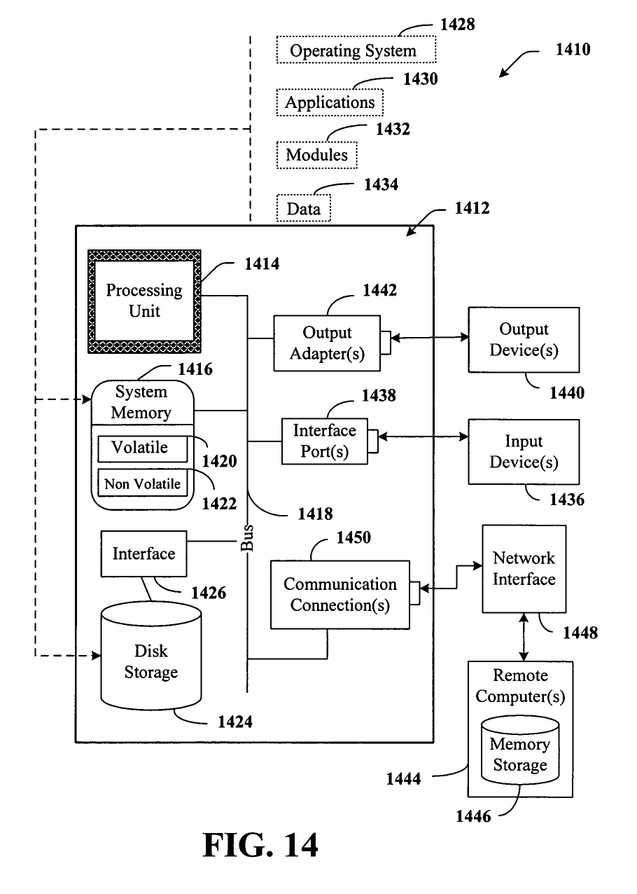

In order to provide additional context for various aspects of the subject invention, FIG. 14 and the following discussion are intended to provide a brief, general description of a suitable operating environment 1410 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1410 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 14, an exemplary environment 1410 for implementing various aspects of the invention includes a computer 1412. The computer 1412 includes a processing unit 1414, a system memory 1416, and a system bus 1418. The system bus 1418 couples system components including, but not limited to, the system memory 1416 to the processing unit 1414. The processing unit 1414 can be any of various available processors. Dual microprocessors and other multiprocessor architectures also can be employed as the processing unit 1414.

The system bus 1418 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable ROM (EEPROM), or flash memory. Volatile memory 1420 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1412 also includes removable/nonremovable, volatile/nonvolatile computer storage media. FIG. 14 illustrates, for example a disk storage 1424. Disk storage 1424 includes, but is not limited to, devices like a magnetic disk drive, floppy disk drive, tape drive, Jaz drive, Zip drive, LS-100 drive, flash memory card, or memory stick. In addition, disk storage 1424 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1424 to the system bus 1418, a removable or non-removable interface is typically used such as interface 1426.

It is to be appreciated that FIG. 14 describes software that acts as an intermediary between users and the basic computer resources described in suitable operating environment 1410. Such software includes an operating system 1428. Operating system 1428, which can be stored on disk storage 1424, acts to control and allocate resources of the computer system 1412. System applications 1430 take advantage of the management of resources by operating system 1428 through program modules 1432 and program data 1434 stored either in system memory 1416 or on disk storage 1424. It is to be appreciated that the subject invention can be implemented with various operating systems or combinations of operating systems.

A user enters commands or information into the computer 1412 through input device(s) 1436. Input devices 1436 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1414 through the system bus 1418 via interface port(s) 1438. Interface port(s) 1438 include, for example, a serial port, a parallel port, a game port, and a universal serial bus (USB). Output device(s) 1440 use some of the same type of ports as input device(s) 1436. Thus, for example, a USB port may be used to provide input to computer 1412, and to output information from computer 1412 to an output device 1440. Output adapter 1442 is provided to illustrate that there are some output devices 1440 like monitors, speakers, and printers among other output devices 1440 that require special adapters. The output adapters 1442 include, by way of illustration and not limitation, video and sound cards that provide a means of connection between the output device 1440 and the system bus 1418. It should be noted that other devices and/or systems of devices provide both input and output capabilities such as remote computer(s) 1444.

Computer 1412 can operate in a networked environment using logical connections to one or more remote computers, such as remote computer(s) 1444. The remote computer(s) 1444 can be a personal computer, a server, a router, a network PC, a workstation, a microprocessor based appliance, a peer device or other common network node and the like, and typically includes many or all of the elements described relative to computer 1412. For purposes of brevity, only a memory storage device 1446 is illustrated with remote computer(s) 1444. Remote computer(s) 1444 is logically connected to computer 1412 through a network interface 1448 and then physically connected via communication connection 1450. Network interface 1448 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1450 refers to the hardware/software employed to connect the network interface 1448 to the bus 1418. While communication connection 1450 is shown for illustrative clarity inside computer 1412, it can also be external to computer 1412. The hardware/software necessary for connection to the network interface 1448 includes, for exemplary purposes only, internal and external technologies such as, modems including regular telephone grade modems, cable modems and DSL modems, ISDN adapters, and Ethernet cards.

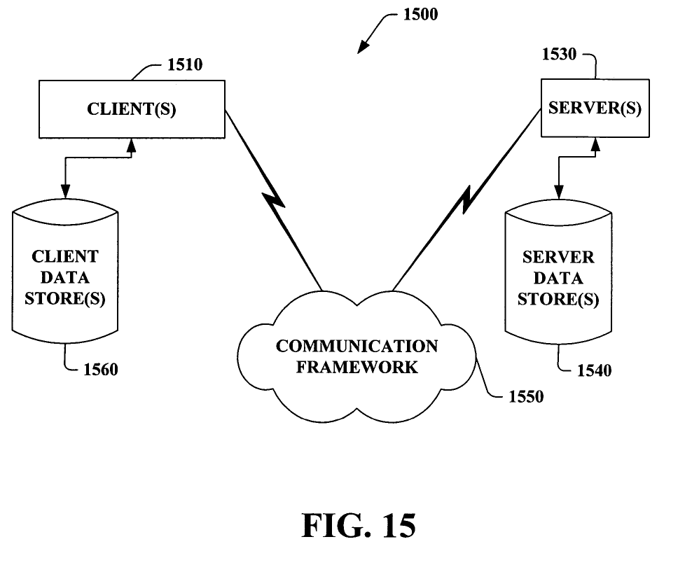

FIG. 15 is a schematic block diagram of a sample-computing environment 1500 with which the subject invention can interact. The system 1500 includes one or more client(s) 1510. The client(s) 1510 can be hardware and/or software (e.g., threads, processes, computing devices). The system 1500 also includes one or more server(s) 1530. The server(s) 1530 can also be hardware and/or software (e.g., threads, processes, computing devices). The servers 1530 can house threads to perform transformations by employing the subject invention, for example. One possible communication between a client 1510 and a server 1530 can be in the form of a data packet adapted to be transmitted between two or more computer processes. The system 1500 includes a communication framework 1550 that can be employed to facilitate communications between the client(s) 1510 and the server(s) 1530. The client(s) 1510 are operably connected to one or more client data store(s) 1560 that can be employed to store information local to the client(s) 1510. Similarly, the server(s) 1530 are operably connected to one or more server data store(s) 1540 that can be employed to store information local to the servers 1530.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An automatic database backup and restoration system, comprising:
an interface component that receives statements relating to backing up at least a portion of a first database, the first database resident upon a consumer computing device; and
a backup component associated with the interface component that automatically copies at least the portion of the first database and writes the copied portion to a backup database, the backup database is a full backup of the first database.

2. The system of claim 1, further comprising:
a monitoring component that detects existence of corrupt data within the first database; and
a restoration component that automatically restores the first database by way of copying data from the backup database and writing the copied data to the first database.

3. The system of claim 2, further comprising a logging component that generates a transactional log with respect to actions undertaken on data within the first database, the restoration component utilizes the transactional log in connection with automatically restoring the first database by way of effectuating transactions against the first database not represented within the backup database.

4. The system of claim 3, the backup component automatically creates a backup of the transactional log.

5. The system of claim 1, further comprising a management component that automatically partitions the first database into database files of a defined size, the backup component copies at least one of the database files in the first database to the backup database to effectuate backing up the first database.

6. The system of claim 5, the backup component copies one or more of the database files at one or more specified times.

7. The system of claim 5, the backup component copies one or more of the database files within a window of time, a precise time within the window of time selected as a function of usage of the first database.

8. The system of claim 5, the management component creates a database file as data is added to the first database.

9. The system of claim 1, further comprising a compression component that compresses the backup database.

10. The system of claim 1, further comprising:
a monitoring component that detects that substantially similar data is corrupt in the first database and the backup database; and
a repair component that acts upon the corrupt data to place the corrupt data in an acceptable form in the first database and the backup database.

11. The system of claim 10, the repair component removes the corrupt data from the first database and the backup database to place the first database and backup database in an acceptable form.

12. The system of claim 1, further comprising a management component that monitors alterations undertaken in the first database, at least the portion to be copied is selected as a function of the monitored alterations.

13. The system of claim 1, further comprising a machine-learning component that makes inferences in connection with selecting the at least portion of the content to copy and a time to copy the at least portion of the first database.

14. The system of claim 1, the consumer computing device is one of a laptop computer, a desktop computer, a personal digital assistant, and a cellular phone.

15. A method that facilitates automatically backing up and restoring a database upon a consumer computing device, comprising:
creating a first database that is a full backup of a second database resident upon the consumer computing device; and
automatically copying data from the first database to the second database upon detecting that the second database includes data subject to corruption.

16. The method of claim 15, the consumer computing device is one of a desktop computer, a laptop computer, a personal digital assistant, and a cellular phone.

17. The method of claim 15, further comprising:
accessing a log file that includes transactions undertaken on the second database but not represented within the first database; and
undertaking at least one of the transactions within the log file against the second database upon copying data from the first database to the second database.

18. The method of claim 15, further comprising:
partitioning the second database into a plurality of database files; and
selectively copying one of the database files from the second database into the first database at a pre-determined time.

19. The method of claim 18, further comprising automatically generating a backup of a log file associated with at least one of the plurality of database files.

20. A system that facilitates automatically backing up and restoring a database, comprising:
means for generating a backup database associated with an original database, at least the original database resident upon a consumer computing device; and
means for automatically restoring the original database upon detection of corrupt data within the original database.
